(19) United States
(12) Patent Application Publication
(10) Pub. No.: US 2002/0020797 A1
(43) Pub. Date: Feb. 21, 2002

(54) Positionable adjustable support arm

(76) Inventor: Kim W. Artz, West Reading, PA (US)

Correspondence Address: DANN DORFMAN HERRELL & SKILLMAN, SUITE 720, 1601 MARKET STREET, PHILADELPHIA, PA, 19103-2307, US

(21) Appl. No.: 09/906,239

(22) Filed: Jul. 16, 2001

Related U.S. Application Data
(63) Continuation of application No. 09/477,074, filed on Jan. 3, 2000.

(51) Int. Cl. F16M 13/00

(52) U.S. Cl. 248/424

(57) ABSTRACT

A positionable adjustable support arm for cups, candles, ashtrays and other similar amenities is provided wherein a bracket is provided for mounting it to any suitable surface. An L-shaped member is rotatably and removably mounted in the bracket. The L-shaped member has a horizontal arm which is adapted to receive a second member which may be adjustably positioned in the horizontal member to adjust the radial length of the arm. The distal end of the second member is provided with a receptacle which may be utilized to hold a cup, an ashtray, candle holder or other item. The position of the receptacle is adjustable both along the axial length and rotatably. The bracket may be utilized to hold two L-shaped members for positioning of two receptacles at various locations.

### FIELD OF THE INVENTION

The present invention is directed to a positionable adjustable support arm for cups, candles, ashtrays and other items. More particularly, the present invention may be readily mounted to the side of a surface, is adjustable in length and may be positioned in various directions.

### BACKGROUND OF THE INVENTION

Cups holders have become an important part of present day society. Various types of items from automobiles to pool lounge chairs are typically provided with cup holders and/or ashtrays. Advertising for new cars often includes the number of cup holders in the vehicles. These have become so popular in demand that new vehicle stickers on expensive vehicles list the number of cup holders.

Although some work has been done in the field of cup or drink holders, none of them provide the advantages of the present invention. U.S. Pat. No. 5,707,036—Dunbar discloses a bathtub book holding device which may be clamped on the side of a bathtub and which includes a cup holder.

U.S. Pat. Nos. 5,199,678—Luebke and 4,270,724—McMullen disclose cup holders attachable to an arm of a chair. U.S. Pat. Nos. 5,628,485—Ray; 5,570,863—Cooper and 4,256,281—Harris et al. disclose various cup and drink holders. However, none of these have the advantages of the present invention.

### SUMMARY OF THE INVENTION

Briefly and basically, in accordance with the present invention, a bracket is provided which is adapted for mounting to a surface. The surface may be the side of a hot tub or spa, a post on a patio or any other substantially vertical surface near where a person may have a desire to enjoy a drink, smoke, enjoy the light of a candle or have a need in general for a movable and positional receptacle. An L-shaped member is provided which has a first leg adapted to be mounted vertically and a second leg adapted to be positioned horizontally. The bracket is adapted to removably receive the first leg of the L-shaped member. A second member is adapted to be adjustably positioned in the second leg or horizontal portion of the L-shaped member. A receptacle is mounted to the second member. The receptacle may receive a drink, an ashtray, candle or other item.

In one embodiment, a second L-shaped member may be provided which has a first leg adapted to be removably mounted to said bracket and rotatably movable with respect to said bracket. The second I-shaped member is provided with a second leg adapted to be adjustably positioned in a horizontal direction.

In a presently preferred embodiment, the L-shaped member and the second member which is horizontally adjustable are constructed of powder coated or anodized aluminum to prevent oxidation.

### BRIEF DESCRIPTION OF THE DRAWINGS

For the purpose of illustrating the invention, there are shown in the drawings forms which are presently preferred; it being understood, however, that this invention is not limited to the precise arrangements and instrumentalities shown.

FIG. 1 is a view in perspective of a positionable adjustable support arm for cups, candles, ashtrays and similar type items in accordance with the present invention.

FIG. 2 is a plan view illustrating the apparatus of the invention mounted to another surface such as a post, and is adjustable both in terms of radial length and rotatable positioning.

FIG. 3 is a cross-sectional view through a center line section taken along line 3-3 of FIG. 1.

FIG. 4 is a cross-sectional view taken along line 4-4 of FIG. 3.

FIG. 5 is an enlarged view of the bracket and receptacle structure with the L-shaped member being shown in dotted outline.

### DETAILED DESCRIPTION OF THE PREFERRED EMBODIMENTS

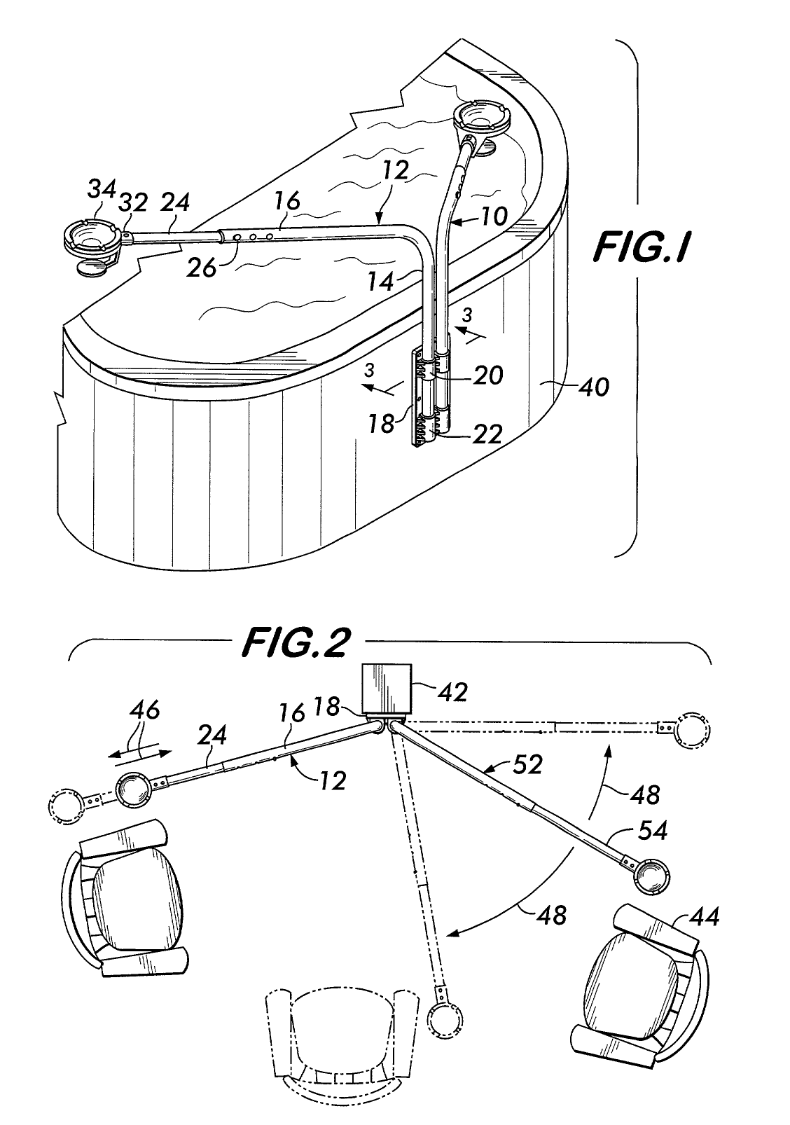

Referring now to the drawings wherein like numerals indicate like elements, there is shown in FIG. 1 a positionable adjustable support arm for cups, candles, ashtrays and the like 10 in accordance with the present invention. Apparatus 10 includes an L-shaped member 12 having a first leg 14 adapted to be mounted vertically and a second leg 16 adapted to be positioned horizontally. First leg 14 is vertically removably and rotatably mounted in bracket 18. An enlarged view of bracket 18 is shown in FIG. 5 wherein first leg 14 is vertically mounted through a set of spaced cylindrical members 20 and 22. Cylindrical member 22 may have a closed bottom 25 or a projection on its lower end which prevents first leg 14 from sliding downwardly. Of course, other arrangements may be utilized to provide this stop function, such as a lip, pin, or projection on leg 14 at the upper edge of cylindrical member 20.

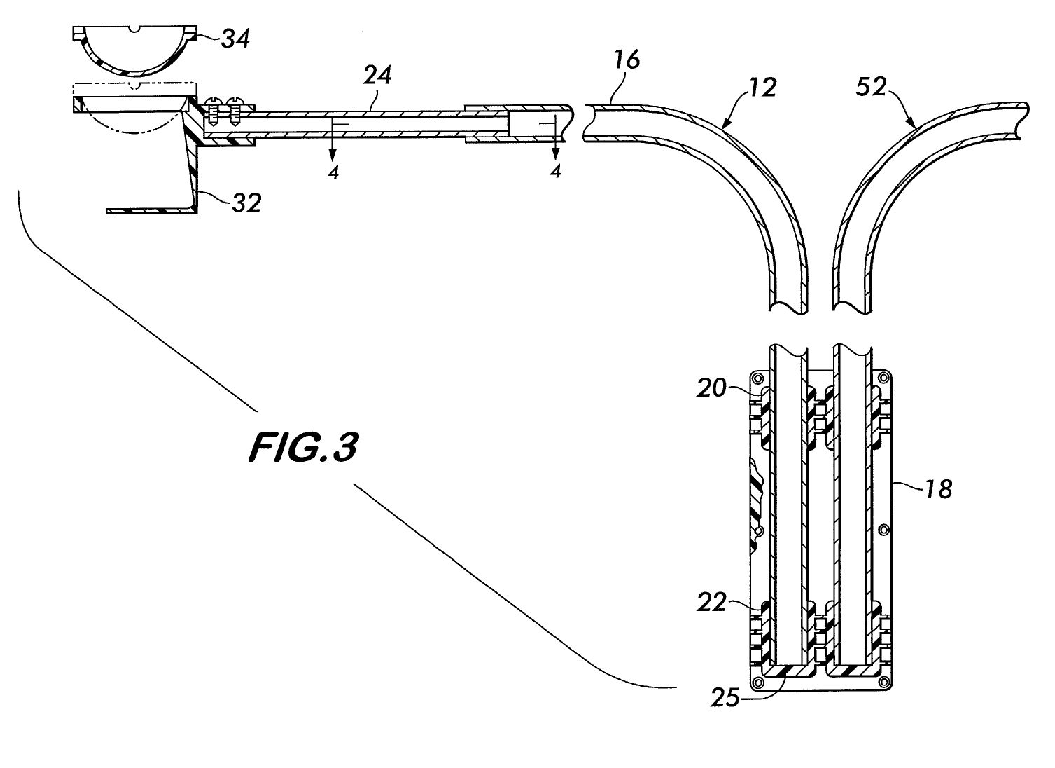

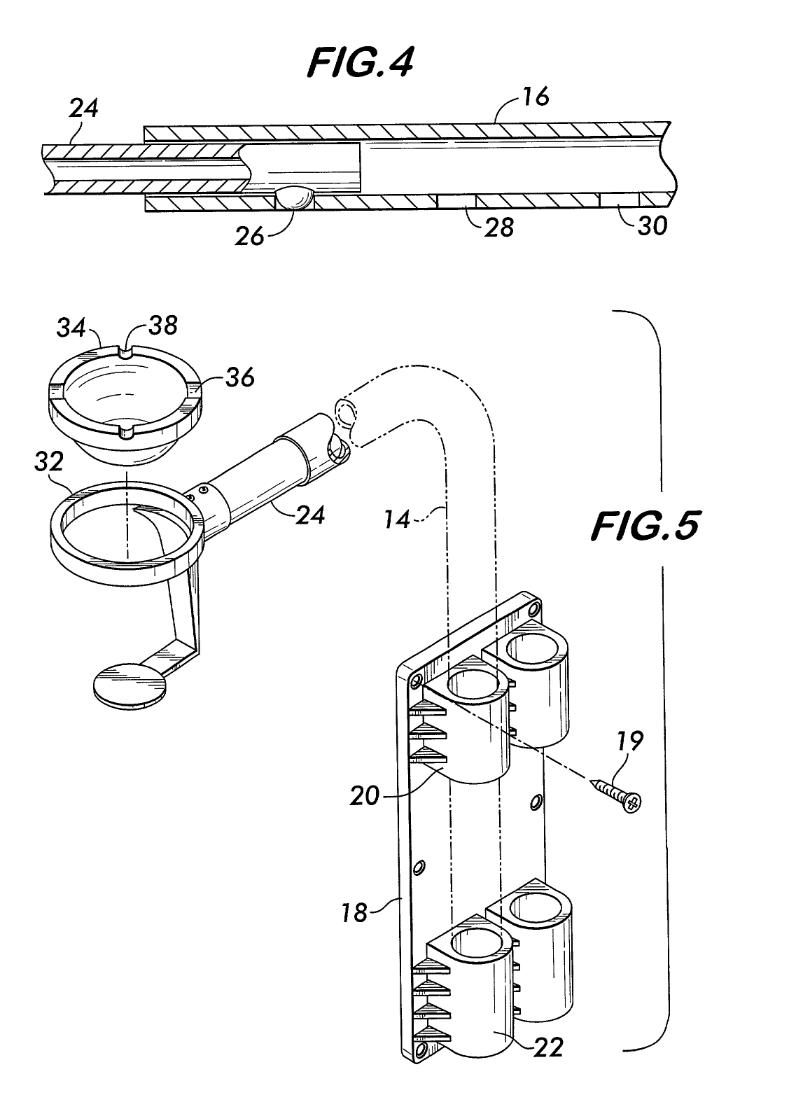

Continuing to refer now to the drawings, and particularly to FIGS. 1 through 3, a second member 24 is adapted to be adjustably positioned in second leg 16 of L-shaped member 12. Second member 24 and L-shaped member 12 may preferably be constructed of powder coated or anodized aluminum to prevent oxidation. Second member 24 is adjustably positionable in second leg 16 and releasably lockable in position by a detent mechanism such as spring loaded ball 26 which may be best seen in FIG. 4. Ball 26 carried by second member 24 may be adjusted to be positioned in one of the other holes 28 or 30 of leg 16 thereby adjusting the radial length of the horizontal section or, in other words, adjusting the position of receptacle 32 mounted to the distal end of second member 24. Receptacle 32 may be utilized to receive a cup or other drink holder, or may be provided with an ashtray, such as ashtray 34. Preferably, ashtray 36 may be provided with, as may be best seen in FIG. 5, larger openings 36 for use in connection with cigars and smaller openings 38 for use in connection with cigarettes.

Bracket 18 may be mounted to any suitable substantially vertical surface in the vicinity where people may desire to enjoy drinks, smoking, candle light or similar amenities. As illustrated in FIG. 1, bracket 18 may be mounted to the side of a hot tub or spa 40. Alternatively, as shown in FIG. 2, bracket 18 may be mounted to any surface such as a post 42 mounted on a patio or the like. Any surface indoors or outdoors may be utilized. Bracket 40 may be mounted to a suitable piece of furniture in a television room or any other area where the amenities described above may be desired to be enjoyed. As may be seen in FIG. 2, chairs or other seating 44 may be suitably placed in appropriate locations.

FIG. 2 illustrates by arrows 46 the radial arm length adjustment directions and arrows 48 illustrate the rotational positioning of L-shaped arms 12 and 52 along with their second members 24 and 54 and their associated receptacles.

As best illustrated in FIG. 5, bracket 18 may be mounted to any suitable surface by screws 19 or any other suitable mounting means including adhesive.

In view of the above, the present invention may be embodied in other specific forms without departing from the spirit or essential attributes thereof and, accordingly, reference should be made to the appended claims, rather than to the foregoing specification as indicating the scope of the invention.

That which is claimed is:

1. A cup holder support for a reservoir, comprising:
a. a liquid reservoir with a wall having a height and a thickness;
b. a mounting bracket attached to the wall of the reservoir;
c. an L-shaped arm having a vertical leg rotatably connected to the bracket, and a transverse leg attached to the vertical leg, wherein the transverse leg intersects the vertical leg at an intersection point that is vertically spaced from the top of the wall so that the transverse leg does not engage the wall when the vertical leg is rotated relative to the bracket; and
d. a beverage holder attached to the transverse arm remote from the intersection of the vertical leg and the horizontal leg.

2. The apparatus of claim 1 comprising a stop for impeding relative displacement of the vertical leg relative to the bracket.

3. The apparatus of claim 1 wherein the transverse leg has a length that is greater than the thickness of the wall such that the transverse leg can be positioned over the wall such that the beverage holder is disposed over the reservoir, remote from the wall.

4. The apparatus of claim 1 wherein the vertical arm is releasably connected to the mounting bracket.

5. The apparatus of claim 1 wherein the transverse arm comprises first and second telescoping arms such that the length of the transverse arm is variable.

6. The apparatus of claim 5 comprising a plurality of spaced apart stops for releasably retaining the first telescoping arm relative to the second telescoping arm.

7. The apparatus of claim 1 wherein the beverage holder comprises a ring and a bottom support attached to the ring and vertically spaced apart from the ring.

8. The apparatus of claim 1 wherein the transverse arm maintains the beverage holder spaced vertically above the bracket.

9. The apparatus of claim 1 wherein the wall is substantially rigid.

10. The apparatus of claim 1 wherein the connection between the L-shaped arm and the mounting bracket allows the L-shaped arm to rotate more than 180 degrees relative to the mounting bracket.
